(19) United States
(12) Patent Application Publication
(10) Pub. No.: US 2026/0195152 A1
(43) Pub. Date: Jul. 9, 2026

(54) USER INTERFACE GENERATION METHOD AND APPARATUS, COMPUTER DEVICE, AND STORAGE MEDIUM

(71) Applicant: Tencent Technology (Shenzhen) company Limited, Shenzhen (CN)

(72) Inventor: Tao WANG, Shenzhen (CN)

(21) Appl. No.: 19/559,681

(22) Filed: Mar. 6, 2026

Related U.S. Application Data
(63) Continuation of application No. PCT/CN2024/116904, filed on Sep. 4, 2024.

(30) Foreign Application Priority Data
Nov. 17, 2023 (CN) 2023/11550312.5

(51) Int. Cl. G06F 9/451; G06F 3/04847

(52) U.S. Cl. CPC G06F 9/451; G06F 3/04847

(57) ABSTRACT

A user interface generation method is performed by a computer device. The method includes: displaying a generation interface in an application in response to a generation instruction in the application; obtaining a keyword inputted on the generation interface, the keyword describing a condition that a target user interface needs to satisfy; generating a first user interface based on the keyword, the first user interface matching the keyword; and displaying the first user interface in the application. This application provides a function of generating a user interface in an application, to achieve personalization of the user interface. The user interface is no longer limited to a user interface created by a designer, attractiveness of the user interface is enhanced, and user stickiness of the application is increased. Moreover, designers do not need to create many different user interfaces, whereby manpower cost is reduced and user interface generation efficiency is enhanced.

### CROSS-REFERENCE TO RELATED APPLICATIONS

This application is a continuation application of PCT Patent Application No. PCT/CN2024/116904, entitled “USER INTERFACE GENERATION METHOD AND APPARATUS, COMPUTER DEVICE, AND STORAGE MEDIUM” filed on September 4, 2024, which claims priority to Chinese Patent Application No. 202311550312.5, entitled "USER INTERFACE GENERATION METHOD AND APPARATUS, COMPUTER DEVICE, AND STORAGE MEDIUM" filed with the China National Intellectual Property Administration on November 17, 2023, both of which are incorporated herein by reference in their entirety.

### FIELD OF THE TECHNOLOGY

Embodiments of this application relate to the field of computer technologies, and in particular, to a user interface generation method and apparatus, a computer device, and a storage medium.

### BACKGROUND OF THE DISCLOSURE

With the development of computer technologies and the emergence of various applications, users are increasingly concerned about display effects of user interfaces in applications. How to generate user interfaces that meet requirements has become a focus of attention. A user interface is typically created by a dedicated designer and added to an application, and then the application is published to a user. The user interface is displayed when the user runs the application.

### SUMMARY

Embodiments of this application provide a user surface generation method and apparatus, a computer device, and a storage medium. The following technical solutions are provided.

In an aspect, a user interface generation method is performed by a computer device. The method includes: displaying a generation interface in an application in response to a generation instruction in the application; obtaining a keyword inputted on the generation interface, the keyword describing a condition that a target user interface needs to satisfy; generating a first user interface based on the keyword, the first user interface matching the keyword; and displaying the first user interface in the application.

In another aspect, a computer device is provided. The computer device includes a processor and a memory, the memory has at least one computer program stored therein, and the at least one computer program is loaded and executed by the processor and causes the computer device to implement operations performed in the user interface generation method in the foregoing aspect.

In another aspect, a non-transitory computer-readable storage medium is provided. The computer-readable storage medium has at least one computer program stored therein, and the at least one computer program is loaded and executed by a processor of a computer device and causes the computer device to implement operations performed in the user interface generation method in the foregoing aspect.

In another aspect, a computer program product is provided, which includes a computer program. The computer program is loaded and executed by a processor, to implement operations performed in the user interface generation method in the foregoing aspect.

According to the solutions of the embodiments of this application, a user interface generation function is provided in the application. When a computer device runs the application, the user interface matching the keyword can be generated based on the inputted keyword. In this way, personalization of the user interface is achieved, the user interface is no longer limited to a user interface created by a designer, attractiveness of the user interface is enhanced, and user stickiness of the application is increased. In addition, designers do not need to create many different user interfaces, whereby manpower cost is reduced and user interface generation efficiency is enhanced.

### BRIEF DESCRIPTION OF THE DRAWINGS

FIG. 1 is a schematic diagram of an implementation environment according to an embodiment of this application.

FIG. 2 is a flowchart of a user interface generation method according to an embodiment of this application.

FIG. 3 is a flowchart of another user interface generation method according to an embodiment of this application.

FIG. 4 is a schematic diagram of a generation interface according to an embodiment of this application.

FIG. 5 is a schematic diagram of another generation interface according to an embodiment of this application.

FIG. 6 is a schematic diagram of another generation interface according to an embodiment of this application.

FIG. 7 is a schematic diagram of another generation interface according to an embodiment of this application.

FIG. 8 is a flowchart of another user interface generation method according to an embodiment of this application.

FIG. 9 is a schematic diagram of a first image generation model according to an embodiment of this application.

FIG. 10 is a schematic diagram of another first image generation model according to an embodiment of this application.

FIG. 11 is a flowchart of another user interface generation method according to an embodiment of this application.

FIG. 12 is a schematic diagram of a line image according to an embodiment of this application.

FIG. 13 is a schematic diagram of a depth image according to an embodiment of this application.

FIG. 14 is a schematic diagram of another first image generation model according to an embodiment of this application.

FIG. 15 is a schematic diagram of an image processing process in a first model according to an embodiment of this application.

FIG. 16 is a schematic diagram of different images generated based on the same line image according to an embodiment of this application.

FIG. 17 is a schematic diagram of different images generated based on the same depth image according to an embodiment of this application.

FIG. 18 is a schematic diagram of different images generated based on the same color image according to an embodiment of this application.

FIG. 19 is a schematic diagram of an operation process of generating a first user interface according to an embodiment of this application.

FIG. 20 is a schematic structural diagram of a user interface generation apparatus according to an embodiment of this application.

FIG. 21 is a schematic structural diagram of another user interface generation apparatus according to an embodiment of this application.

FIG. 22 is a schematic structural diagram of a terminal according to an embodiment of this application.

FIG. 23 is a schematic structural diagram of a server according to an embodiment of this application.

### DESCRIPTION OF EMBODIMENTS

To make the objectives, technical solutions, and advantages of embodiments of this application clearer, implementations of this application will be described in further detail below with reference to the accompanying drawings. Information (including but not limited to user device information, user personal information, and the like), data (including but not limited to data for analysis, stored data, displayed data, and the like), and signals (including but not limited to signals transmitted between a user terminal and another device) involved in this application are all authorized by users or fully authorized by all parties, and collection, use, and processing of relevant data need to comply with relevant laws and regulations and standards of relevant countries and regions.

In the related art, a user interface is typically created by a dedicated designer and added to an application, and then the application is published to a user. The user interface is displayed when the user runs the application. However, for different users, the same user interface is created by the designer. The user interface lacks attractiveness and leads to low user stickiness of the application Based on this, the embodiments of this application provide an interface generation method, to enhance user stickiness of an application. In this way, designers do not need to create many different user interfaces, and user interface generation efficiency is enhanced. The following introduces the interface generation method provided in the embodiments of this application in detail.

First, terms involved in the embodiments of this application will be introduced below.

Contrastive Language-Image Pre-Training (CLIP) encoder: it is a pre-trained model that compares text with images, configured to establish a correspondence between text and images. In the embodiments of this application, a text encoding function of the CLIP is primarily utilized, to convert text into a text feature that can be inputted into a model for image generation.

Text feature: it is a string of digital codes configured for describing information, such as a property, an attribute, and a structure, of text. Because a computer device cannot recognize text, the text is converted into a text feature, and the computer device can recognize the text feature and perform a subsequent image generation process based on the text feature.

Image feature: it is a string of digital codes configured for describing information, such as a size, a color distribution, an outline, and a texture, of an image. Because a computer device cannot recognize an image, the image is converted into an image feature, and the computer device can recognize the image feature and perform a subsequent image generation process based on the image feature.

Variational Auto Encoder (VAE): it is a generative model based on probability encoding, including an encoder and a decoder. The encoder is configured to convert an image into an image feature in a latent space, and the decoder is configured to convert the image feature in the latent space into a pixel image.

Denoising Diffusion Probabilistic Models (DDPM): they are a type of generative model based on a diffusion model, which generates data through diffusion in a high-dimensional space, can simulate a complex probability distribution, and can dynamically change a model structure in a training process, to better fit data.

Noise prediction: in a denoising process of an image, a noise image is determined by using a DDPM algorithm starting from random noise, and an image obtained by removing a noise image from an original image is a generated new image.

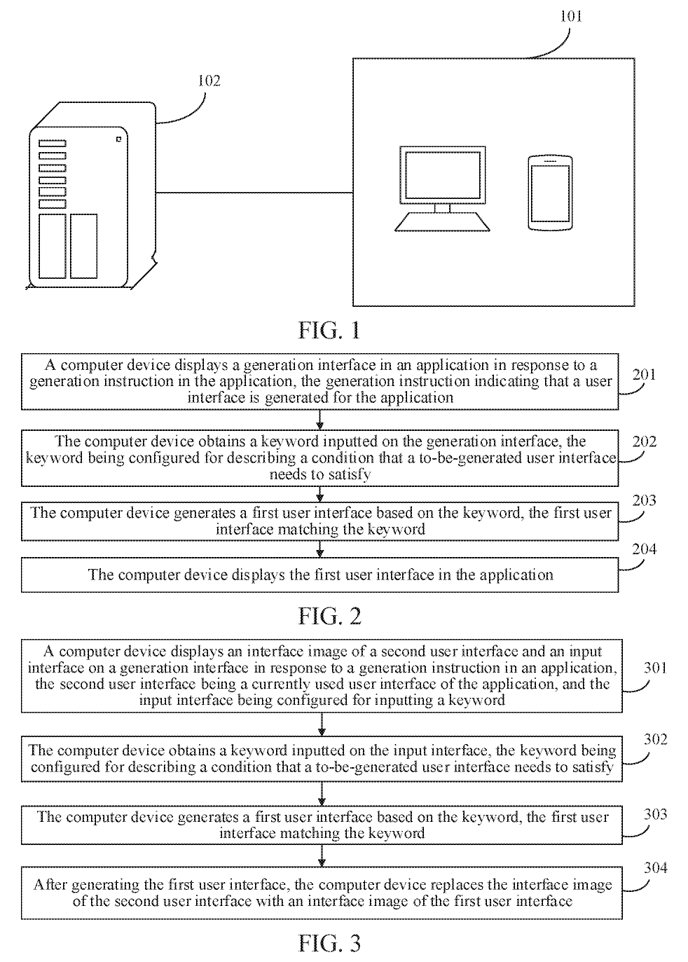

FIG. 1 is a schematic diagram of an implementation environment according to an embodiment of this application. Refer to FIG. 1. The implementation environment includes: a terminal 101 and a server 102, and the terminal 101 and the server 102 are connected via a wireless or wired network.

The terminal 101 runs an application, and the server 102 is associated with the application, to provide a data service for the application. The application is of various types, such as an instant messaging application, a game application, or a resource recommendation application. This is not limited in the embodiments of this application. In view of a fact that if a designer creates a user interface of an application, and different users see the same user interface, which lacks attractiveness, in the embodiments of this application, a function of customizing a user interface is added to the application. To be specific, after the terminal 101 runs the application, a user can trigger a generation instruction in the application and enter a keyword, to generate a user interface matching the keyword. In this way, the user interface is not limited to the user interface created by the designer. When using the terminal 101 to run the application, different users can respectively generate personalized user interfaces, and do not need to use the same user interface.

The user interface generation method provided in the embodiments of this application is applied to a computer device. In an embodiment, the computer device is the terminal 101 or the server 102.

In a possible implementation, the computer device is the terminal 101, and the terminal 101 generates a user interface through an application.

In an embodiment, the terminal 101 is, but is not limited to, a smartphone, a tablet computer, a notebook computer, a desktop computer, a smart speaker, a smartwatch, a smart voice interaction device, a smart household appliance, an on-board terminal, or an aircraft. The embodiments of this application may be applied to various scenarios, including but not limited to a cloud technology, artificial intelligence, intelligent transportation, and assisted driving.

In another possible implementation, the computer device includes the terminal 101 and the server 102. After the terminal 101 runs an application, a user triggers a generation instruction in the application and enters a keyword. The terminal 101 uploads the keyword to the server 102. The server 102 generates a user interface and then returns the user interface to the terminal 101. The terminal 101 can display the user interface through the application.

In an embodiment, the server 102 is an independent physical server, or a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

In a possible implementation, computer programs involved in the embodiments of this application may be deployed on one computer device for execution, or may be executed on a plurality of computer devices at one location, or may be executed on a plurality of computer devices distributed at a plurality of locations and connected via a communication network. The plurality of computer devices distributed at the plurality of locations and connected via the communication network can form a blockchain system.

In a possible implementation, the computer device configured to generate the user interface in the embodiments of this application is a node in a blockchain system. The node can store the generated user interface in a blockchain, and then the node or a node corresponding to another device in the blockchain may query the user interface by accessing the blockchain.

The user interface generation method provided in the embodiments of this application may be applied to various scenarios in which an application is run.

For example, in a game scenario, a designer of a game application creates a user interface file, the user interface file stipulates a style of an in-match user interface in the game application, adds the user interface file to the game application, and then publishes the game application. After downloading and installing the game application, a player may start a match through the game application, and a user interface displayed in the match is the user interface created by the designer. However, the player may alternatively generate a personalized user interface in the game application by the method provided in the embodiments of this application. Then, when the player starts a match through the application, a user interface displayed in the match is the user-defined user interface. This is extremely personalized and customized experience for the player. The player can use his/her own creativity to create various user interfaces.

FIG. 2 is a flowchart of a user interface generation method according to an embodiment of this application. The embodiments of this application are performed by a computer device. Refer to FIG. 2. The method includes:

201: The computer device displays a generation interface in an application in response to a generation instruction in the application, the generation instruction indicating that a user interface is generated for the application.

When the embodiments of this application are applied to the computer device running the application, a user of the computer device is a user of the application. The user triggers the generation instruction in the application. The generation instruction indicates that the user interface (UI) is generated for the application. The generation interface is configured for the user to set a keyword required for generating the user interface.

The generation instruction may be generated through any operation in the application. In a possible implementation, a user interface generation control is displayed in the application. The user interface generation control is configured for requesting generation of the user interface for the application, the generation instruction is generated through a trigger operation for the user interface generation control, and the computer device displays the generation interface in response to the trigger operation for the user interface generation control. The trigger operation is a click/tap operation, a double-click/double-tap operation, or the like. The user interface generation control is located on a main interface of the application, or located on another interface of the application. This is not limited in the embodiments of this application.

202: The computer device obtains a keyword inputted on the generation interface, the keyword being configured for describing a condition that a target user interface needs to satisfy.

The keyword is configured for describing the condition that the target user interface needs to satisfy. A user may start from a requirement of the user and enter a keyword of the user on the generation interface, to generate a user interface matching the keyword. For different users, different keywords are inputted, and different user interfaces are generated. In this way, personalization of the user interface is achieved. In addition, because the process of generating the user interface in the embodiment of this application is intelligent rather than user-designed, the generated user interface has randomness. Therefore, even if the same keyword is inputted, the computer device may generate different user interfaces based on the same keyword.

203: The computer device generates a first user interface based on the keyword, the first user interface matching the keyword.

For ease of distinguishing, in the embodiments of this application, the user interface that is generated at this time and that matches the keyword is referred to as the first user interface. However, the operations in the embodiments of this application may be performed for a plurality of times, to generate a plurality of user interfaces.

In an embodiment, after generating the first user interface, the computer device closes the generation interface, and when detecting a generation instruction again, performs operation 201 to operation 203 again to generate a new user interface. A new keyword is inputted on the generation interface, to generate a user interface matching the new keyword. Alternatively, when the computer device generates the first user interface and does not close the generation interface, a keyword is re-inputted on the generation interface, to generate a user interface matching the new keyword. Alternatively, when the computer device generates the first user interface and does not close the generation interface, the originally inputted keyword may be kept unchanged, and a regeneration control on the generation interface is triggered, to generate another user interface matching the keyword.

In the embodiments of this application, a user interface file is set in the application. The user interface file represents a style of a user interface, such as a shape, a color, or a size of a display element, or a layout or spacing of a plurality of display elements. During running of the application, a visual user interface can be displayed based on the user interface file. In this case, that the computer device generates the user interface matching the keyword refers to that the computer device generates a user interface file matching the keyword. This ensures that the user interface matching the keyword can be displayed based on the user interface file during subsequent running of the application. The user interface file is in a Portable Network Graphics (PNG) format or another format. This is not limited in the embodiments of this application.

In an embodiment, different user interface files are respectively set for different functions in the application, and the user interface generation method provided in the embodiments of this application may be applied to any function. For example, the application is a game application, the game application is provided with a match function and a non-match function, a match user interface file provided by the game application represents a style of an in-match user interface, and an off-match user interface file represents a style of an off-match user interface, such as a main interface of the game application or an account information presentation interface of the game application. The style of the in-match user interface significantly affects a game operation of a user, and the style of the off-match user interface does not significantly affect a game operation of a user. Therefore, a function of customizing a user interface may be enabled for the match function, and the function of customizing a user interface may not be enabled for the non-match function. In this case, the generation instruction in the embodiments of this application indicates that a user interface file is generated for the match function of the application, and the computer device generates a match user interface file matching the keyword, and keeps an original off-match user interface file unchanged.

In an embodiment, the computer device is a terminal. The terminal generates a user interface file by performing operation 201 to operation 203, and then the terminal takes the user interface file into effect. During subsequent running of the application, a user interface can be displayed based on the user interface file. For example, when the terminal generates a plurality of user interface files, the last generated user interface file may be taken into effect by default, or a user may select any user interface file to be taken into effect from the plurality of user interface files.

In a possible implementation, after generating the user interface file, the terminal uploads the user interface file to a server through the application, and the server stores an account logged in to the terminal and the user interface file.

In an embodiment, the computer device includes a terminal and a server. After the terminal runs the application, a user triggers the generation instruction in the application and enters the keyword, the terminal uploads the keyword to the server, the server generates the user interface file matching the keyword and returns the user interface file to the terminal, the terminal takes the user interface file into effect through the application, to display the user interface matching the keyword based on the user interface file.

In another possible implementation, the server stores the account logged in to the terminal and the user interface file.

In another possible implementation, the computer device displays a user interface ranking list. The user interface ranking list includes a plurality of user interfaces, and each user interface in the user interface ranking list is generated by the computer device running the application.

In an embodiment, the user interface ranking list includes a target number of user interfaces. The target number may be a preset number. To be specific, after at least one computer device running the application generates the user interface, a plurality of user interfaces may be evaluated, the target number of user interfaces that have a relatively good display effect are selected, to create the user interface ranking list, the user interface ranking list is published in the application, and the computer device running the application may display the user interface ranking list in the application. In addition, that each user interface in the user interface ranking list is generated by the computer device running the application represents that the selected user interface is not created by a designer of the application, but is user-defined when the user uses the application. The user interface ranking list allows a large number of users of the application to view generated user interfaces with rich styles. In this way, more users are attracted to participate in customization of user interfaces. The user interfaces on the list may be selected by an operator of the application, or the user interfaces on the list may be selected by user voting. This is not limited in the embodiments of this application.

204: The computer device displays the first user interface in the application.

In a possible implementation, after generating the first user interface, the computer device displays the first user interface in the application in response to an application instruction for the first user interface, to use the generated personalized first user interface.

In the related art, during development of an application, a designer creates a user interface for the application, adds the user interface to the application after the user interface is created, and then publishes the application. A computer device runs the application after downloading the application, to display the user interface of the application. This operation process is time-consuming and requires relatively high manpower cost. For different users, the same user interface of the application is displayed. Even if the designer creates different user interfaces for users to choose from, the selection range of the users is limited. In addition, a display effect of the user interface depends on the designer. However, creativity of the designer is limited. Consequently, the designer creates limited user interfaces.

According to the solution in the embodiments of this application, the function of generating a user interface is provided in the application, and when the computer device runs the application, the user interface matching the keyword can be generated based on the inputted keyword. In this way, personalization of the user interface is achieved. The user interface is no longer limited to the user interface created by the designer, attractiveness of the user interface is enhanced, and user stickiness of the application is increased. In addition, designers do not need to create many different user interfaces, whereby manpower cost is reduced and user interface generation efficiency is enhanced.

Based on the embodiment shown in FIG. 2, the embodiments of this application further provide another user interface generation method. FIG. 3 is a flowchart of another user interface generation method according to an embodiment of this application. The embodiments of this application are performed by a computer device. Refer to FIG. 3. The method includes:

301: The computer device displays an interface image of a second user interface and an input interface on a generation interface in response to a generation instruction in an application, the second user interface being a currently used user interface of the application, and the input interface being configured for inputting a keyword.

The generation instruction indicates that a user interface is generated for the application. The generation interface includes the interface image of the second user interface and the input interface. The input interface is configured for inputting a keyword, the second user interface is the currently used user interface of the application, and the interface image of the second user interface is an image when the application displays the second user interface. A difference between the second user interface and the interface image of the second user interface lies in that: when the application displays the second user interface, various operations can be performed based on the second user interface, such as clicking/tapping a control on the second user interface, or the computer device responds to an instruction inputted through a keyboard when the second user interface is displayed. In contrast, the interface image of the second user interface is only an image, and operations cannot be performed based on the interface image of the second user interface, such as clicking/tapping a control in the interface image of the second user interface, or the computer device does not respond to an instruction inputted through a keyboard. The interface image of the second user interface can present a display effect when the application displays the second user interface. By displaying the interface image of the second user interface on the generation interface, a user can preview the display effect of the second user interface and determine whether the display effect of the second user interface is satisfactory. The currently used second user interface of the application may be a user interface created by a designer, or a user interface previously generated by the computer device.

In a possible implementation, the computer device generates the interface image of the second user interface based on a currently used user interface file. Because the currently used user interface file indicates a style of the second user interface, the interface image of the second user interface that is generated based on the user interface file can present the display effect when the application displays the second user interface.

In a possible implementation, the computer device divides the generation interface into a first display area and a second display area, displays the interface image of the second user interface in the first display area, and displays the input interface in the second display area. Alternatively, the computer device displays the interface image of the second user interface at the bottom of the generation interface, and displays the input interface on the top of the interface image of the second user interface. The input interface may be a transparent interface, to avoid blocking the interface image of the second user interface, or the input interface is a non-transparent interface, and a size of the input interface is smaller than a size of the interface image of the second user interface, to ensure that the input interface blocks only a partial area of the interface image of the second user interface, but does not block the whole area of the interface image of the second user interface.

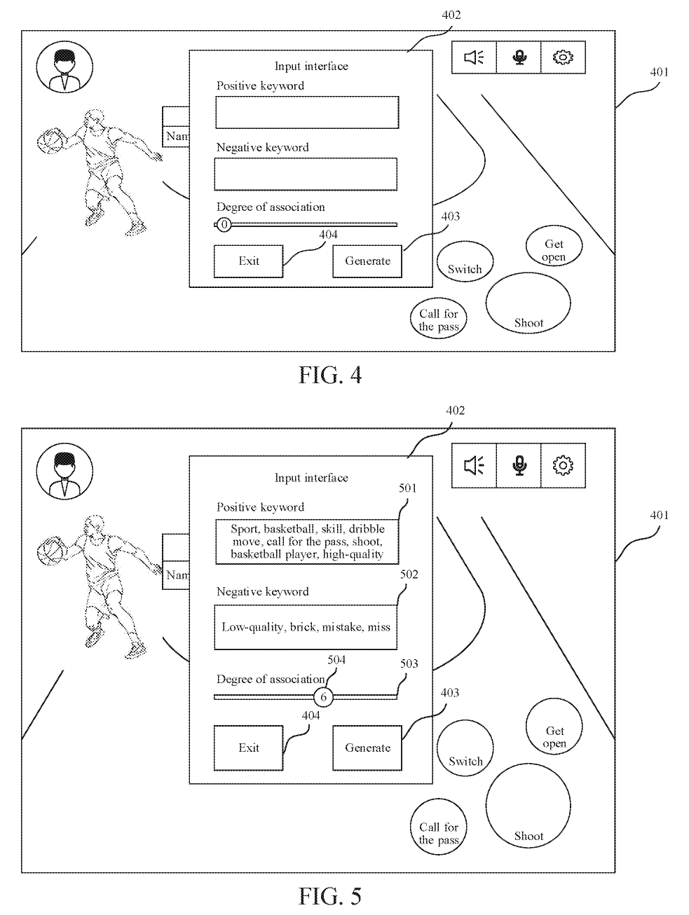

For example, the generation interface is shown in FIG. 4. The generation interface displays an interface image 401 of a second user interface and an input interface 402. The input interface 402 is located on the top of the interface image 401 of the second user interface.

302: The computer device obtains a keyword inputted on the input interface, the keyword being configured for describing a condition that a target user interface needs to satisfy.

The user enters the keyword on the input interface on the generation interface. After obtaining the keyword based on the generation interface, the computer device can generate a user interface matching the keyword.

In a possible implementation, referring to FIG. 4, the input interface displays a generation control 403. After entering the keyword, the user triggers the generation control 403. In response to a trigger operation for the generation control 403, the computer device obtains the keyword inputted on the input interface, to generate the user interface matching the keyword.

In another possible implementation, referring to FIG. 4, the input interface further displays an exit control 404. Before entering the keyword, or when intending to cancel generation of a user interface after entering the keyword, the user may trigger the exit control 404. In response to a trigger operation for the exit control 404, the computer device cancels displaying the generation interface, or keeps displaying the generation interface and cancels displaying the input interface on the generation interface.

In another possible implementation, operation 302 includes:

3021: The computer device obtains a positive keyword inputted in a first input field of the input interface.

The computer device displays the first input field on the input interface, and obtains the positive keyword based on an input operation in the first input field. The positive keyword is a keyword that needs to be associated with the target user interface. The first input field is displayed on the input interface, and the first input field is configured for inputting a positive keyword. The positive keyword is a keyword that needs to be associated with the target user interface, that is, a user interface to be generated at the request of a user needs to be a user interface associated with the positive keyword. For example, a display element associated with the positive keyword is displayed on the target user interface, or a style of the target user interface conforms to a style indicated by the positive keyword. For example, as shown in FIG. 5, a first input field 501 is displayed on the input interface. The user enters a plurality of positive keywords in the first input field 501, to represent that the target user interface needs to be associated with the plurality of positive keywords. For example, the positive keyword includes "sport", and a sport style is presented on the target user interface.

In the embodiments of this application, an example in which the generation interface includes the input interface and the input interface displays the first input field is used. In another embodiment, the first input field may be located at any position of the generation interface, and the computer device obtains the positive keyword inputted in the first input field of the generation interface.

In another possible implementation, operation 302 further includes:

3022: The computer device obtains a negative keyword inputted in a second input field of the input interface.

The computer device displays the second input field on the generation interface, and obtains the negative keyword based on an input operation in the second input field. The negative keyword is a keyword that does not need to be associated with the target user interface. The second input field is displayed on the input interface, and the second input field is configured for inputting a negative keyword. The negative keyword is a keyword that does not need to be associated with the target user interface, that is, a user interface to be generated at the request of a user needs to be a user interface unassociated with the negative keyword. For example, a display element associated with the negative keyword is not displayed on the target user interface, or a style of the target user interface does not conform to a style indicated by the negative keyword. For example, as shown in FIG. 5, a second input field 502 is displayed on the input interface. The user enters a plurality of negative keywords in the second input field 502, to represent that the target user interface needs to be unassociated with the plurality of negative keywords. For example, the negative keyword includes "miss", the target user interface does not include a match image related to "miss".

In the embodiments of this application, an example in which the generation interface includes the input interface and the input interface displays the second input field is used. In another embodiment, the second input field may be located at any position of the generation interface, and the computer device obtains the negative keyword inputted in the second input field of the generation interface.

In another possible implementation, the computer device may further perform operation 3023:

3023: The computer device obtains a degree of association represented by a position of a slider thumb in a slider of the input interface.

The computer device displays the slider on the generation interface, the slider includes the slider thumb, and the position of the slider thumb represented the degree of association. The degree of association is a degree of association between the target user interface and the positive keyword. The degree of association represented by the position of the slider thumb is obtained based on a sliding operation for the slider thumb. The slider is displayed on the input interface, the slider thumb is disposed on the slider, and the position of the slider thumb in the slider represents the degree of association. The degree of association is a degree of association between the target user interface and the positive keyword, namely, how high is the association between the target user interface and the positive keyword. The degree of association may be in a numerical form, a percentage form, or another form. A higher degree of association represents that the generated user interface is more associated with the positive keyword, and a lower degree of association represents that the generated user interface is less associated with the positive keyword. The user can change the position of the slider thumb in the slider by dragging the slider thumb, to change the degree of association. For example, if the degree of association degree is relatively small, a size of a display element associated with the positive keyword on the target user interface is relatively small, or if the degree of association is relatively large, the size of the display element associated with the positive keyword on the target user interface is relatively large. Alternatively, if the degree of association is relatively small, more display elements that conform to a style of the positive keyword are displayed on the target user interface, or if the degree of association is relatively large, and fewer display elements that conform to the style of the positive keyword are displayed on the target user interface.

In a possible implementation, the degree of association degree is displayed in a display area of the slider thumb, and a user can intuitively view the degree of association. For example, as shown in FIG. 5, a slider 503 is displayed on the generation interface, and a position of a slider thumb 504 in the slider 503 represents a degree of association. The slider thumb 504 is located at the leftmost end of the slider 503, representing that the degree of association is 0, and the slider thumb 504 is located at the rightmost end of the slider 503, representing that the degree of association is 10. The position of the slider thumb 504 in FIG. 5 represents that the degree of association is 6.

In the embodiments of this application, an example in which the generation interface includes the input interface and the input interface displays the slider is used. In another embodiment, the slider may be located at any position of the generation interface, and the computer device obtains the degree of association corresponding to the position of the slider thumb in the slider on the generation interface.

303: The computer device generates a first user interface based on the keyword, the first user interface matching the keyword.

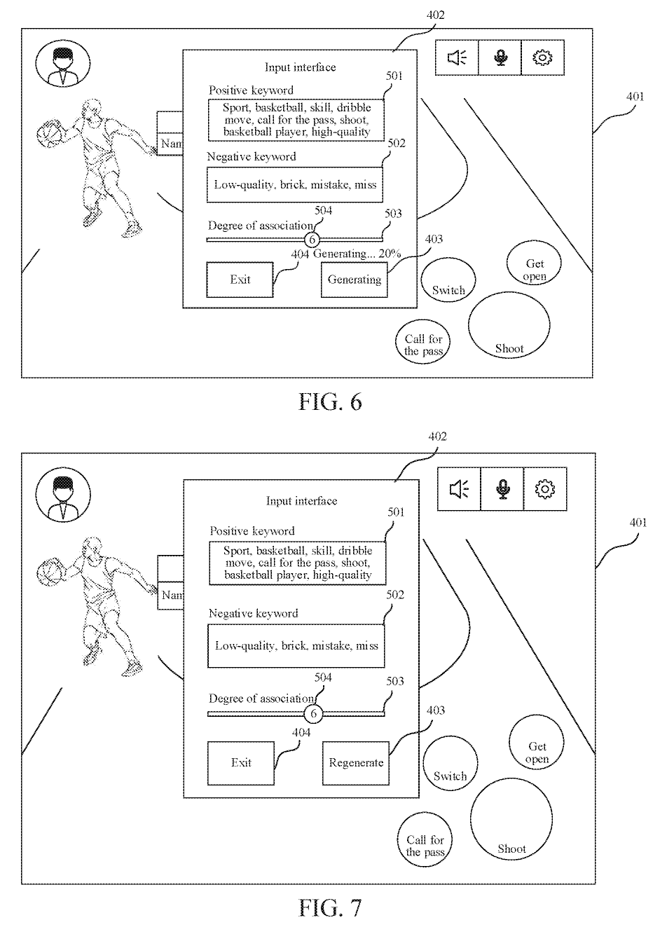

For example, as shown in FIG. 5 and FIG. 6, prompt text displayed in the generation control 403 is "Generate". After entering the keyword, the user clicks/taps the generation control 403, and the computer device starts to generate the first user interface. The prompt text displayed in the generation control 403 is changed to "Generating", and progress prompt text "Generating... 20%" of generating the first user interface is further displayed above the generation control 403. In addition, in this process, if the user clicks/taps the exit control 404, generation of the first user interface is stopped. Alternatively, as shown in FIG. 7, after the first user interface is generated, the prompt text displayed in the generation control 403 is changed to "Regenerate", and then if the user clicks/taps the generation control 403, the computer device generates another user interface matching the keyword again.

In a possible implementation, when the keyword includes a positive keyword, the computer device generates an interface image associated with the positive keyword, and then generates the first user interface based on the interface image. For example, the interface image includes a display element (a control, a color, or the like) associated with the positive keyword, or a style of the interface image conforms to a style of the positive keyword.

In another possible implementation, when the keyword includes a negative keyword, the computer device generates an interface image that is associated with the positive keyword and that is unassociated with the negative keyword, and then generates the first user interface based on the interface image. For example, the interface image includes a display element associated with the positive keyword and does not include a display element associated with the negative keyword, or a style of the interface image conforms to the style of the positive keyword and does not conform to a style of the negative keyword.

In another possible implementation, when the computer device obtains a positive keyword and a degree of association, the computer device generates an interface image that is associated with the positive keyword and that has a degree of association with the positive keyword equal to the degree of association, and then generates the first user interface based on the interface image. For example, the interface image includes a display element associated with the positive keyword, and a size of the display element conforms to a size indicated by the degree of association.

304: After generating the first user interface, the computer device replaces the interface image of the second user interface with an interface image of the first user interface.

The interface image of the first user interface is an image when the application displays the first user interface. The interface image of the first user interface can present a display effect when the application displays the first user interface. A difference between the first user interface and the interface image of the first user interface lies in that: when the application displays the first user interface, various operations can be performed based on the first user interface, such as clicking/tapping a control on the first user interface, or the computer device responds to an instruction inputted through a keyboard when the first user interface is displayed. In contrast, the interface image of the first user interface is only an image, and operations cannot be performed based on the interface image of the first user interface, such as clicking/tapping a control in the interface image of the first user interface, or the computer device does not respond to an instruction inputted through a keyboard. The computer device replaces the interface image of the second user interface with the interface image of the first user interface. In this way, a user can preview the display effect of the first user interface, and can further intuitively view a difference between the first user interface and the second user interface.

According to the solution in the embodiments of this application, the function of generating a user interface is provided in the application, and when the computer device runs the application, the user interface matching the keyword can be generated based on the inputted keyword. In this way, personalization of the user interface is achieved. The user interface is no longer limited to the user interface created by the designer, attractiveness of the user interface is enhanced, and user stickiness of the application is increased. In addition, designers do not need to create many different user interfaces, whereby manpower cost is reduced and user interface generation efficiency is enhanced.

In addition, before generation of the first user interface is started, by displaying the interface image of the second user interface on the generation interface, the display effect when the application displays the second user interface can be presented, and the user can preview the display effect of the second user interface, to determine whether the user is satisfied with the display effect of the second user interface. In addition, after the first user interface is generated, by replacing the interface image of the second user interface on the generation interface with the interface image of the first user interface, the display effect when the application displays the first user interface can be presented, and the user can preview the display effect of the first user interface and intuitively view the difference between the first user interface and the second user interface. In addition, the positive keyword is inputted on the generation interface, to generate the user interface associated with the positive keyword. Therefore, the user can specify a type of a user interface to be generated, to meet a requirement of the user for the user interface. Furthermore, different user interfaces can be generated by inputting different positive keywords. In this way, diversity of the user interfaces is increased, attractiveness of the user interfaces is enhanced, and user stickiness of the application is increased. In addition, the negative keyword is inputted on the generation interface, to generate the user interface unassociated with the negative keyword. Therefore, the user can specify a type of a user interface to be extruded from generation, to meet a requirement of the user for the user interface. Furthermore, different user interfaces can be generated by inputting different negative keywords. In this way, diversity of the user interfaces is increased, attractiveness of the user interfaces is enhanced, and user stickiness of the application is increased. In addition, the positive keyword and the degree of association are inputted on the generation interface, to generate the user interface that is associated with the positive keyword and has the degree of association with the positive keyword equal to the degree of association. In this way, a requirement of the user for the user interface is met. Furthermore, different user interfaces may be generated by inputting different degrees of association. In this way, diversity of the user interfaces is increased, attractiveness of the user interfaces is enhanced, and user stickiness of the application is increased.

In another possible implementation, operation 303 includes: a target interface image is generated based on the interface image of the second user interface and the keyword through a first image generation model, and the first user interface is generated based on the target interface image.

The second user interface is a currently used user interface of the application. The first image generation model is configured to generate an image. The target interface image can be generated by inputting the interface image of the second user interface and the keyword into the first image generation model. The interface image of the second user interface and the keyword are two pieces of important input content of the first image generation model, which can ensure that the generated target interface image not only matches the keyword, but also includes partial image information of the interface image of the second user interface, and does not significantly differ from the interface image of the second user interface. In a possible implementation, the interface image of the first user interface mentioned in operation 304 is the target interface image generated through the first image generation model.

In the embodiments of this application, the artificial intelligence technology is employed, a user interface can be directly generated through an image generation model, and users can create various user interfaces by using their creativity. In this way, user experience is enhanced, user stickiness of the application is increased, and development cost is reduced.

In an embodiment, the application in the embodiments of this application is a game application. In the related art, a designer needs to spend a large amount of time in creating a UI of a game application, and players basically have no options for choosing a UI. Even if the designer creates several sets of UIs for players to choose from, the selection range of the players is limited, and a number of UIs is relatively small. Neither of these game applications creates a game UI through a model, and cannot allow players to customize UIs. In the embodiments of this application, the artificial intelligence technology is combined with the game UI. This allows players to directly generate UIs through an image generation model in a game application, and brings a highly personalized and customized experience to players. Players can create various UIs by using their creativity, and customize their favorite buttons, interface themes, and the like, with more variety and richer options. In this way, game experience and game fun of players are improved. Moreover, more activities and gameplay are brought to the game application, activeness of the game application is increased, user stickiness of the game application is also increased, and development cost of the game application is reduced. This is very beneficial to both the game application and players.

The embodiments of this application further provide another user interface generation method, in which a process of generating a first user interface through a first image generation model is described in detail. FIG. 8 is a flowchart of another user interface generation method according to an embodiment of this application. The embodiments of this application are performed by a computer device. Refer to FIG. 8. The method includes:

801: The computer device displays a generation interface in an application in response to a generation instruction in the application, the generation instruction indicating that a user interface is generated for the application.

802: The computer device obtains a keyword inputted on the generation interface, the keyword being configured for describing a condition that a target user interface needs to satisfy.

Processes of operation 801 and operation 802 are similar to the processes of operation 201 and operation 202. Details are not described again here.

803: The computer device encodes an interface image of a second user interface, to obtain an image feature.

In the embodiments of this application, although the computer device needs to generate a new first user interface, to ensure normal running of the application, the first user interface needs to implement a function that is originally set on the second user interface of the application. This requires that a difference between the first user interface and the second user interface cannot be excessively large. Therefore, when the first user interface is generated, the interface image of the second user interface is also taken into account. Therefore, the computer device encodes the interface image of the second user interface, to obtain the image feature. That is, dimension reduction is performed on the interface image of the second user interface. In this way, the interface image of the second user interface can be dimensionally reduced from a previous larger pixel level to an image feature of a smaller size. The image feature is inputted into a first image generation model, to allow the image feature to participate in a model operation process.

In an embodiment, the computer device encodes the interface image of the second user interface through a VAE, to obtain the image feature, or encodes the interface image of the second user interface through a CLIP encoder, to obtain the image feature, or may encode the interface image of the second user interface by another encoding method. This is not limited in the embodiments of this application.

804: The computer device encodes the keyword, to obtain a text feature.

To generate the first user interface matching the keyword, the keyword needs to be encoded to obtain the text feature. Then, the text feature is inputted into the first image generation model, to allow the text feature to participate in a model operation process.

In an embodiment, the computer device encodes the keyword through a VAE, to obtain the text feature, or encodes the keyword through a CLIP encoder, to obtain the text feature, or may encode the keyword by another encoding method. This is not limited in the embodiments of this application.

In a possible implementation, when the keyword includes a positive keyword, the positive keyword is encoded, to obtain the text feature. In a possible implementation, when the keyword includes a positive keyword and a negative keyword, the positive keyword and the negative keyword are encoded, to obtain the text feature. In another possible implementation, when the computer device obtains a positive keyword and a degree of association, because the degree of association is represented in a form of a feature and can be directly inputted into the first image generation model without encoding, the computer device encodes the positive keyword to obtain the text feature, and inputs the text feature and the degree of association into the first image generation model. In another possible implementation, when the computer device obtains a positive keyword, a negative keyword, and a degree of association, the computer device encodes the positive keyword and the negative keyword, to obtain the text feature, and then inputs the text feature and the degree of association into the first image generation model.

Certainly, in another possible implementation, when a degree of association is obtained, the degree of association can also be encoded. In this way, the text feature obtained through encoding includes the degree of association.

805: The computer device encodes the text feature and the image feature through a first encoding sub-model, to obtain an encoded feature.

In the embodiments of this application, the first image generation model includes the first encoding sub-model, and the first encoding sub-model is configured to encode any feature. The computer device inputs the text feature and the image feature into the first encoding sub-model, and the first encoding sub-model encodes the text feature and the image feature and outputs the encoded feature.

In a possible implementation, when a degree of association is obtained, the computer device encodes the image feature, the text feature, and the degree of association through the first encoding sub-model, to obtain the encoded feature. In the first image generation model, the text feature interacts with the image feature, and the degree of association affects parameters of the first image generation model when the text feature interacts with the image feature, to control a generated target interface image.

806: The computer device decodes the encoded feature through a decoding sub-model, to obtain a target interface image.

In the embodiments of this application, the first image generation model includes the decoding sub-model, and the decoding sub-model is configured to decode any feature. The computer device inputs the encoded feature into the decoding sub-model, and the decoding sub-model decodes the encoded feature and outputs the target interface image.

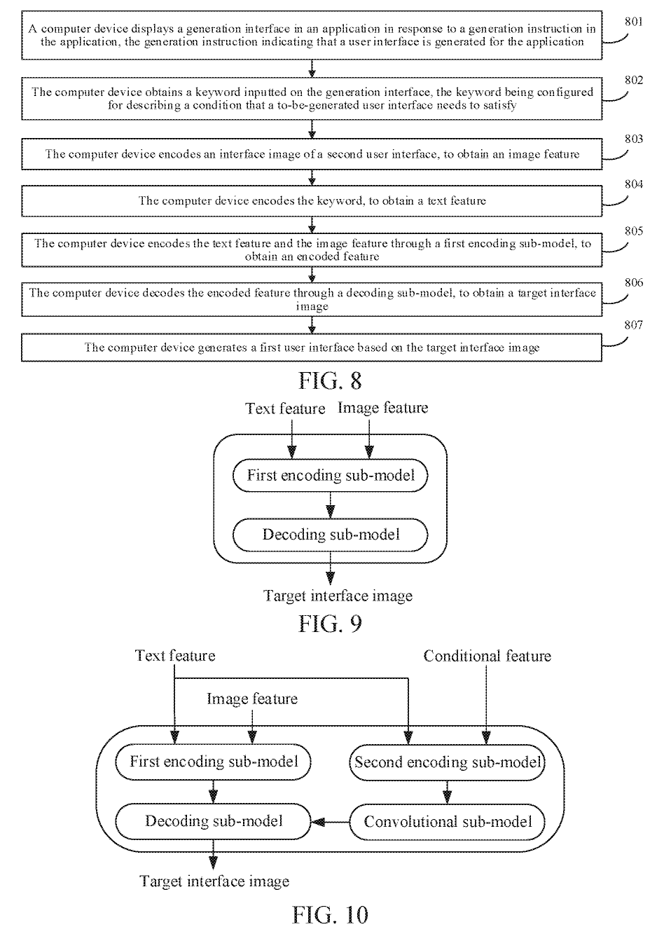

In operation 803 to operation 806, the target interface image is generated based on the interface image of the second user interface and the keyword through the first image generation model. In a possible implementation, as shown in FIG. 9, the first image generation model includes a first encoding sub-model and a decoding sub-model. The computer device inputs the image feature and the text feature into the first image generation model, and after performing encoding through the first encoding sub-model, decodes, through the decoding sub-model, the feature obtained through encoding, to generate a new image, namely, the target interface image. By using the model structure shown in FIG. 9, because the process of generating the target interface image is affected by the interface image of the second user interface, it can be ensured that the generated target interface image does not significantly differ from the interface image of the second user interface, and normal running of the application is not affected. Because the process of generating the target interface image is affected by the keyword, it can be ensured that the generated target interface image is an image matching the keyword, and a requirement of a user can be met.

807: The computer device generates a first user interface based on the target interface image.

After generating the target interface image, the computer device converts the target interface image into a user interface file, and the user interface file represents a style of the first user interface. This is equivalent to that the computer device generates the first user interface, and the first user interface can be displayed based on the user interface file during subsequent running of the application.

In a possible implementation, the computer device recognizes the target interface image, to obtain a plurality of interface elements in the target interface image and positions of the plurality of interface elements, and generates the first user interface based on the plurality of interface elements and the positions of the plurality of interface elements. In an embodiment, the computer device obtains an interface template, and fills the interface template with the plurality of interface elements according to the positions of the plurality of interface elements, to obtain the first user interface.

In a possible implementation, the computer device includes a terminal and a server. The terminal performs operation 801 and operation 802, and the server performs operation 803 to operation 806. After the target interface image is generated, the user interface file is generated based on the target interface image through a file generation server. To be specific, operation 807 includes: the server transmits the target interface image to the file generation server, the file generation server converts the target interface image into the user interface file and returns the user interface file to the server, the server receives the user interface file and transmits the user interface file to the terminal, and the terminal stores the user interface file and displays the first user interface based on the user interface file during running of the application.

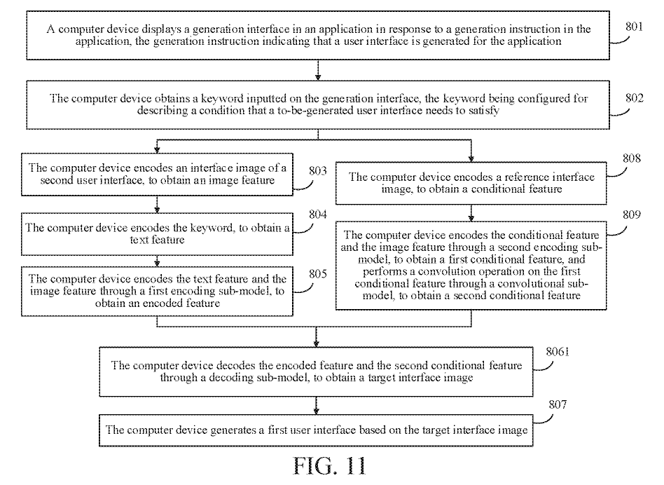

In a possible implementation, as shown in FIG. 10, the first image generation model further includes a second encoding sub-model and a convolutional sub-model. As shown in FIG. 11, the operation of generating a target interface image based on the interface image of the second user interface and the keyword through the first image generation model further includes operation 808 and operation 809.

808: The computer device encodes a reference interface image, to obtain a conditional feature.

In the embodiments of this application, the reference interface image includes partial image information of the interface image of the second user interface, the conditional feature is an image feature of the reference interface image, and the conditional feature indicates that the target interface image generated through the first image generation model needs to include the foregoing image information. Subsequently, the conditional feature is inputted into the first image generation model, that is, the conditional feature is allowed to participate in an operation process. In this way, the target interface image generated by the first image generation model includes the foregoing image information.

In an embodiment, the reference interface image is an image obtained after processing the interface image of the second user interface. For example, the reference interface image is obtained by removing first image information from the interface image of the second user interface and retaining second image information. The first image information is preset image information that does not need to be retained, and the second image information is preset image information that needs to be retained.

For example, a process of obtaining the reference interface image includes at least one of the following:

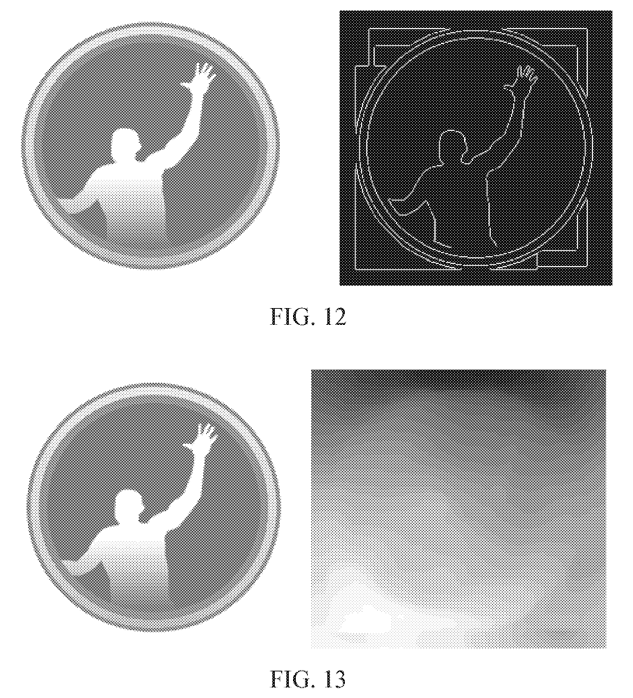

1. A line image of the interface image of the second user interface is obtained, the line image including a line in the interface image of the second user interface. For example, the interface image and the line image of the second user interface are shown in FIG. 12. By performing line extraction on the interface image of the second user interface, a line of at least one display element in the interface image of the second user interface can be extracted, the line of the at least one display element is retained in the line image, and information, such as a color or depth, inside the line of the display element is no longer retained. When the target interface image is subsequently generated based on the line image through the first image generation model, it can be ensured that a line of the at least one display element in the target interface image is the same as or similar to the line of the at least one display element in the interface image of the second user interface, to avoid a relatively large difference.

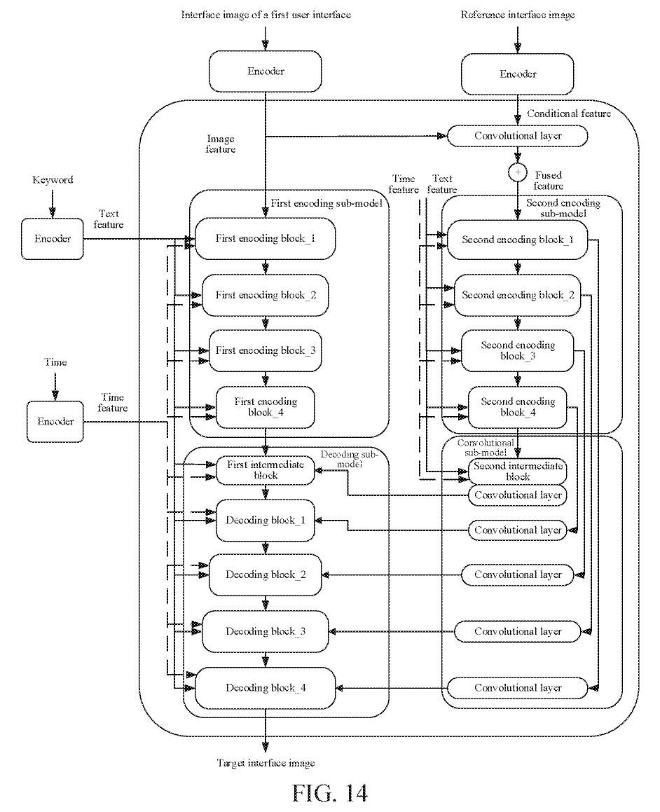

2. A depth image of the interface image of the second user interface is obtained, the depth image including a depth of each position in the interface image of the second user interface. For example, the interface image and the depth image of the second user interface are shown in FIG. 13. By performing depth extraction on the interface image of the second user interface, the depth of each position in the interface image of the second user interface can be extracted, the depth of each position is retained in the depth image, and information, such as a color, of each position is no longer retained. In this way, a perspective relationship between the positions in the interface image of the second user interface is retained, and a front, middle, and rear relationship between the positions in the interface image of the second user interface can be taken as a reference object. When the target interface image is subsequently generated based on the depth image through the first image generation model, it can be ensured that a depth of each position in the target interface image is the same as or similar to the depth of each position in the interface image of the second user interface, to avoid a relatively large difference. A perspective experience generated when a user views the target interface image is the same as or similar to a perspective experience generated when the user views the interface image of the second user interface.

3. A color image of the interface image of the second user interface is obtained, the color image including a main color of each area in the interface image of the second user interface. By performing color recognition on the interface image of the second user interface, the interface image of the second user interface can be divided according to different colors, to determine the main color of each divided area, the main color of each area is retained in the color image, and information, such as a depth or line, of each area is no longer retained. When the target interface image is subsequently generated based on the color image through the first image generation model, it can be ensured that a main color of each area in the target interface image is the same as or similar to the main color of each area in the interface image of the second user interface, to avoid a relatively large difference. In the embodiments of this application, an example in which the reference interface image includes the line image, the depth image, or the color image is used. In another embodiment, the reference interface image may alternatively be another type of image. This is not limited in the embodiments of this application.

In an embodiment, the reference interface image is encoded through a VAE or a CLIP encoder, to obtain the conditional feature.

809: The computer device encodes the conditional feature and the image feature through a second encoding sub-model, to obtain a first conditional feature, and performs a convolution operation on the first conditional feature through a convolutional sub-model, to obtain a second conditional feature.

In this possible implementation, operation 806 includes:

8061: The computer device decodes the encoded feature and the second conditional feature through a decoding sub-model, to obtain a target interface image.

The computer device processes the conditional feature and the text feature through the second encoding sub-model and the convolutional sub-model, to obtain the second conditional feature. To make the generated target interface image controllable, the second conditional feature is allowed to participate in the decoding process of the decoding sub-model. Therefore, the computer device decodes the encoded feature and the second conditional feature through the decoding sub-model, to obtain the target interface image.

The reference interface image is taken as a condition, and the reference interface image is introduced into the image generation process of the first image generation model. This can ensure that the generated target interface image includes partial image information of the interface image of the second user interface, and does not significantly differ from the interface image of the second user interface. For example, the application is a game application with basketball-playing functionality. The interface image of the second user interface includes operation controls such as a shoot control, a call-for-pass control, a switch control, and an escape control. These operation controls are operation controls that need to be used when a user participates in a basketball match. In this case, the target interface image generated based on the interface image of the second user interface also includes these operation controls, to ensure that a basketball match can be proceed normally. However, a style of the operation control in the target interface image is different from a style of the operation control in the interface image of the second user interface.

According to the solution in the embodiments of this application, the function of generating a user interface is provided in the application, and when the computer device runs the application, the user interface matching the keyword can be automatically generated based on the inputted keyword through the image generation model. In this way, personalization of the user interface is achieved. The user interface is no longer limited to the user interface created by the designer, attractiveness of the user interface is enhanced, and user stickiness of the application is increased. In addition, designers do not need to create many different user interfaces, whereby manpower cost is reduced and user interface generation efficiency is enhanced.

Based on the first image generation model shown in FIG. 10, the embodiments of this application further provide another first image generation model. A structure of the first image generation model is shown in FIG. 14. The first image generation model includes a first encoding sub-model, a second encoding sub-model, a convolutional sub-model, and a decoding sub-model. Furthermore, the first encoding sub-model includes n first encoding blocks, the second encoding sub-model includes n second encoding blocks, the convolutional sub-model includes n convolutional layers, and the decoding sub-model includes n decoding blocks, n being an integer greater than 1.

Operation 805 includes: a text feature and an image feature are encoded through the first first encoding block, to obtain the first encoded feature; the text feature and the (x–1)^{th} encoded feature are encoded through the x^{th} first encoding block, to obtain the x^{th} encoded feature, until the text feature and the (n–1)^{th} encoded feature are encoded through the n^{th} first encoding block, to obtain the n^{th} encoded feature, x being an integer greater than 1 but less than n. The n first encoding blocks are sequentially connected. The text feature and the image feature are inputted into the first first encoding block, and the first first encoding block outputs the first encoded feature. The text feature and the first encoded feature are inputted into the second first encoding block, and the second first encoding block outputs the second encoded feature. The text feature and the second encoded feature are inputted into the third first encoding block, the third first encoding block outputs the third encoded feature, and so on until the last first encoding block outputs the last encoded feature, that is, until the n^{th} first encoding block outputs the n^{th} encoded feature.

Operation 809 includes: a convolution operation is performed on a conditional feature, and a conditional feature obtained after the convolution operation is fused with the image feature, to obtain a fused feature; the text feature and the fused feature are encoded through the first second encoding block, to obtain the first first conditional feature; the text feature and the (y–1)^{th} first conditional feature are encoded through the y^{th} second encoding block, to obtain the y^{th} first conditional feature, until the text feature and the (n–1)^{th} first conditional feature are encoded through the n^{th} second encoding block, to obtain the n^{th} first conditional feature, y being an integer greater than 1 but less than n; and a convolution operation is performed on the n first conditional features respectively through the n convolutional layers, to obtain n second conditional features. The n second encoding blocks are sequentially connected. The text feature and the fused feature are inputted into the first second encoding block, and the first second encoding block outputs the first first conditional feature. The text feature and the first first conditional feature are inputted into the second second encoding block, and the second second encoding block outputs the second first conditional feature. The text feature and the second first conditional feature are inputted into the third second encoding block, the third second encoding block outputs the third first conditional feature, and so on until the last second encoding block outputs the last first conditional feature, that is, until the n^{th} second encoding block outputs the n^{th} first conditional feature. Each second encoding block is connected to a respective corresponding convolutional layer. After each second encoding block outputs the first conditional feature, the first conditional feature outputted by the second encoding block is inputted into the convolutional layer corresponding to the second encoding block, and the convolutional layer outputs one second conditional feature. In an embodiment, the m^{th} second encoding block is connected to an (n+1–m)^{th} convolutional layer, and the (n+1–m)^{th} convolutional layer outputs the (n+1–m)^{th} second conditional feature. For example, after the first second encoding block outputs the first first conditional feature, the first first conditional feature is inputted into the convolutional layer corresponding to the first second encoding block, and the convolutional layer outputs the n^{th} second conditional feature.

Operation 8061 includes: the text feature, the n^{th} encoded feature, and the first second conditional feature are decoded through the first decoding block, to obtain the first decoded feature; the text feature, the (n+1–z)^{th} encoded feature, and the z^{th} second conditional feature are decoded through the z^{th} decoding block, to obtain the z^{th} decoded feature, until the text feature, the first decoded feature, and the n^{th} second conditional feature are decoded through the n^{th} decoding block, to obtain the n^{th} decoded feature, z being an integer greater than 1 but less than n; and a target interface image is generated based on the n^{th} decoded feature.

In a possible implementation, as shown in FIG. 14, a first intermediate block is further included between the first encoding sub-model and the decoding sub-model. The first intermediate block processes the n^{th} encoded feature, and inputs the processed encoded feature into the decoding sub-model for decoding. In addition, a second intermediate block is further included between the second encoding sub-model and the convolutional sub-model. The second intermediate block processes the n^{th} first conditional feature, and inputs the processed first conditional feature into the first intermediate block for processing.

In another possible implementation, as shown in FIG. 14, the computer device further performs iterative processing. Each time after obtaining the n^{th} decoded feature through the decoding sub-model, the computer device further inputs the n^{th} decoded feature as an updated image feature into the first image generation model, and performs processing again through the first image generation model. When a number of iterations reaches a target number T of times, the n^{th} decoded feature that is outputted by the decoding sub-model and that is obtained in a current iteration is decoded, to obtain the target interface image, T being an integer greater than 1. A decoder employed for decoding the n^{th} decoded feature may be a VAE decoder or another decoder. A time shown in FIG. 14 represents a current number of iterations. That is, in each iteration, the current number of iterations can be encoded, to obtain a time feature. The time feature is also inputted into the first image generation model, and is subjected to processing, such as encoding or decoding, together with the text feature, to obtain the n^{th} decoded feature corresponding to the current number of iterations. The n^{th} decoded feature corresponding to the current number of iterations is decoded, to obtain the target interface image.

In a possible implementation, a training process of the first image generation model includes: a second image generation model is trained, the second image generation model including a first encoding sub-model and a decoding sub-model; when the second image generation model satisfies a training end condition, the first encoding sub-model is copied, to obtain the second encoding sub-model; the second encoding sub-model and the convolutional sub-model are added to the second image generation model, to obtain the first image generation model; and the first image generation model is trained when model parameters of the first encoding sub-model are kept unchanged, until the first image generation model satisfies the training end condition. The first encoding sub-model may be referred to as a locked copy, and the second encoding sub-model may be referred to as a trainable copy. After initial training of the first encoding sub-model and the decoding sub-model ends, the model parameters of the first encoding sub-model are kept unchanged, and then the second encoding sub-model and the convolutional sub-model are added. The second encoding sub-model reuses the model parameters of the first encoding sub-model. The first image generation model is trained when the model parameters of the first encoding sub-model are kept unchanged. In a training process, fine tuning is performed on the model parameters of the second encoding sub-model until training of the first image generation model ends.

Therefore, the first image generation model is divided into two modules. The first module is the first encoding sub-model and the decoding sub-model. The first module retains an original image generation process of the first image generation model, and the generation process of the first module is related to a model structure and model parameters of the first module. The second module is the second encoding sub-model, the convolutional sub-model, and the decoding sub-model. The second encoding sub-model is a copy model of the first encoding sub-model. After encoding is performed through the first encoding sub-model, the second module applies an effect of a reference interface image (a line image, a depth image, a color image, or the like) to a decoding process of the decoding sub-model. In this way, the generated target interface image is affected by a line, a depth, and a color of the interface image of the second user interface. That is, the target interface image that is different from the interface image of the second user interface and that is controlled is generated, to prevent the generated user interface from affecting normal running of the application.

In a possible implementation, the training the second image generation model includes: the second image generation model is trained based on a first model; and the training the first image generation model includes: the first image generation model is trained based on at least one model of a second model, a third model, and a fourth model. The first model includes at least one image, and a text keyword and diffusion information of the at least one image. The second model includes at least one line image, and a text keyword and diffusion information of the at least one line image. The third model includes at least one depth image, and a text keyword and diffusion information of the at least one depth image. The fourth model includes at least one color image, and a text keyword and diffusion information of the at least one color image. The diffusion information of any image includes a noise image obtained by adding noise to the image and the noise.

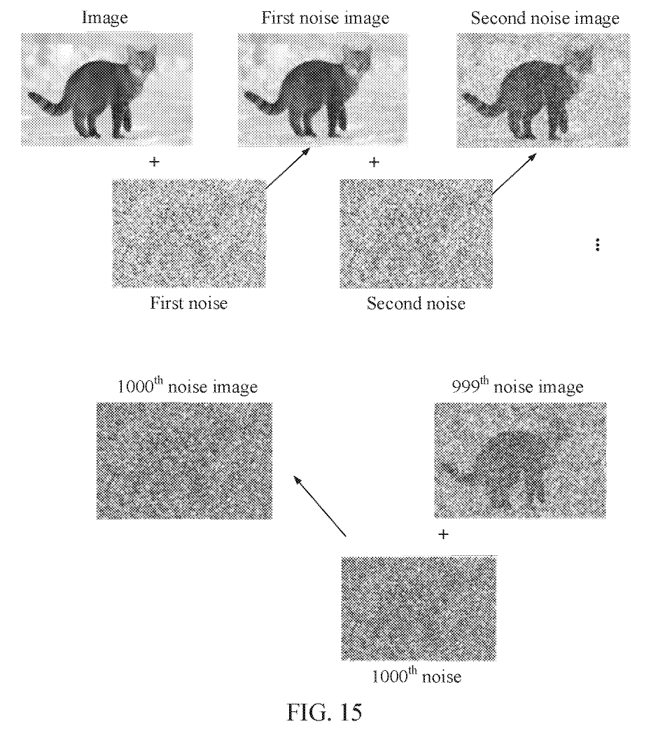

First, as shown in FIG. 15, a first model is set in a second image generation model. The first model includes a plurality of images. For each image, a text keyword of the image is set, and diffusion information of the image is obtained through processing by using a DDPM algorithm. Specifically, the first noise is generated, the first noise is superimposed with an image to obtain the first noise image, and the first noise image and the first noise are recorded. Then, the second noise is continuously generated, the second noise is superimposed with the first noise image to obtain the second noise image, and the second noise image and the second noise are recorded. By analogy, a plurality of noise images of the image and the noise respectively corresponding to the plurality of noise images are obtained. A number of times of noise addition may be any set value.

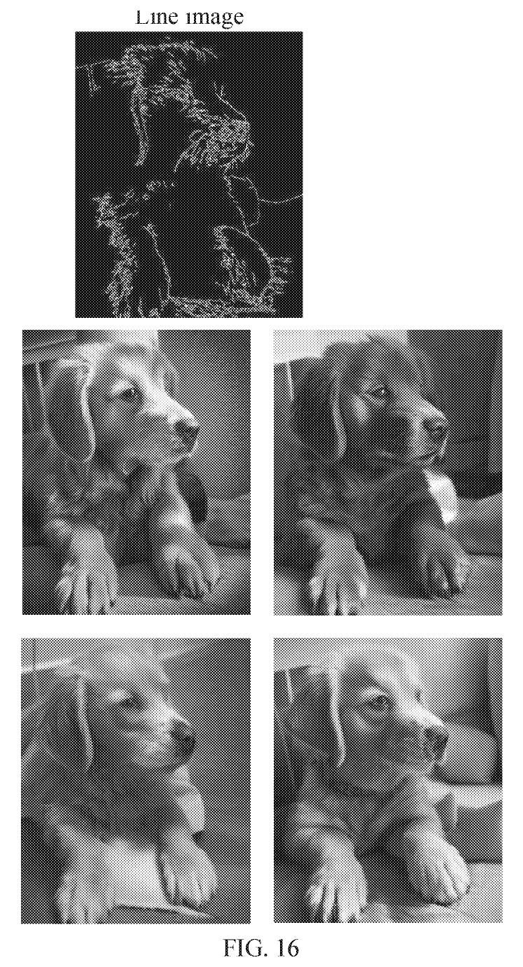

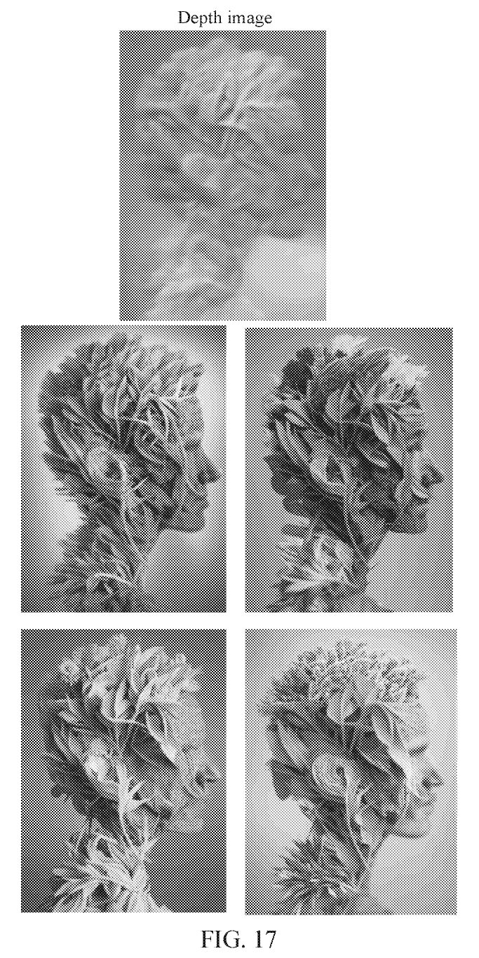

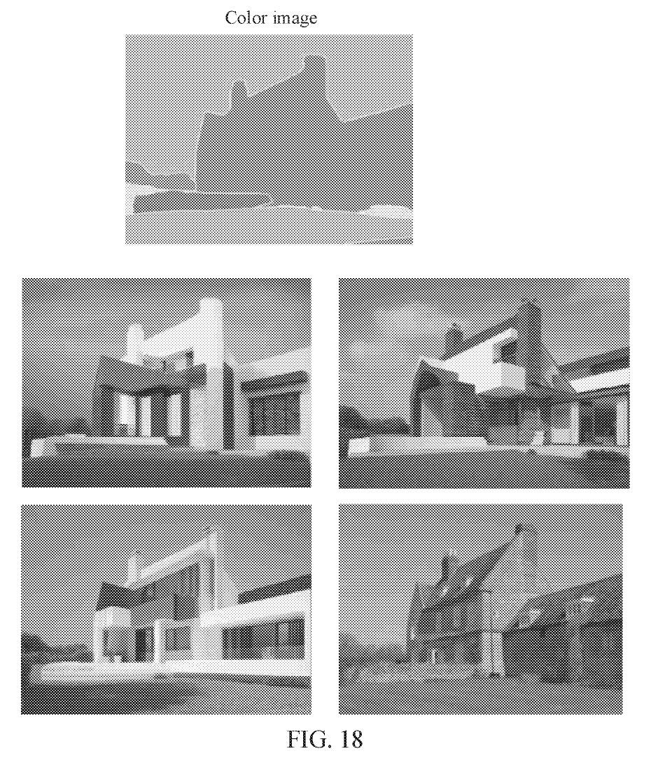

In addition, a second model, a third model, and a fourth model are set in the first image generation model. The second model includes a plurality of line images. For each line image, a text keyword of the line image is set. When reference is made to a line in the line image, diffusion information of the line image is obtained through processing by using the DDPM algorithm. As shown in FIG. 16, when a line restriction condition is added, lines in different images generated based on the same line image are the same or similar. The third model includes a plurality of depth images. For each depth image, a text keyword of the depth image is set. When reference is made to a depth of the depth image, diffusion information of the depth image is obtained through processing by using the DDPM algorithm. As shown in FIG. 17, when a depth restriction condition is added, depths of the same positions in different images generated based on the same depth image are the same or similar. The fourth model includes a plurality of color images. For each color image, a text keyword of the color image is set. When reference is made to a color in the color image, diffusion information of the color image is obtained through processing by using the DDPM algorithm. As shown in FIG. 18, when a color restriction condition is added, main colors of the same areas in different images generated based on the same color image are the same or similar. A process of creating diffusion information for an image in the second model, the third model, and the fourth model is the same as that of the first model. Details are not described again here.

In an embodiment, the second image generation model is a diffusion model, such as a Stable Diffusion model or another diffusion model. The second encoding sub-model and the convolutional sub-model may form ControlNet.

In a training process of the diffusion model, the diffusion model may be trained by taking any one or more images in the first model as input samples and taking noise already added to the samples as output samples, to endow the diffusion model with a capability of predicting noise, that is, the diffusion model may serve as a noise predictor. In this way, a process of generating a new image through the diffusion model is simulated as a process of predicting noise in an original image and removing the noise. However, in a training process after ControlNet is introduced, the diffusion model and ControlNet may be trained by taking any one or more images in the second model, the third model, and the fourth model as reference, to endow the diffusion model with a capability of predicting noise under the constraints of line images, depth images, or color images. In this way, performance of the diffusion model is enhanced, and a display effect of a user interface generated through the diffusion model is enhanced.

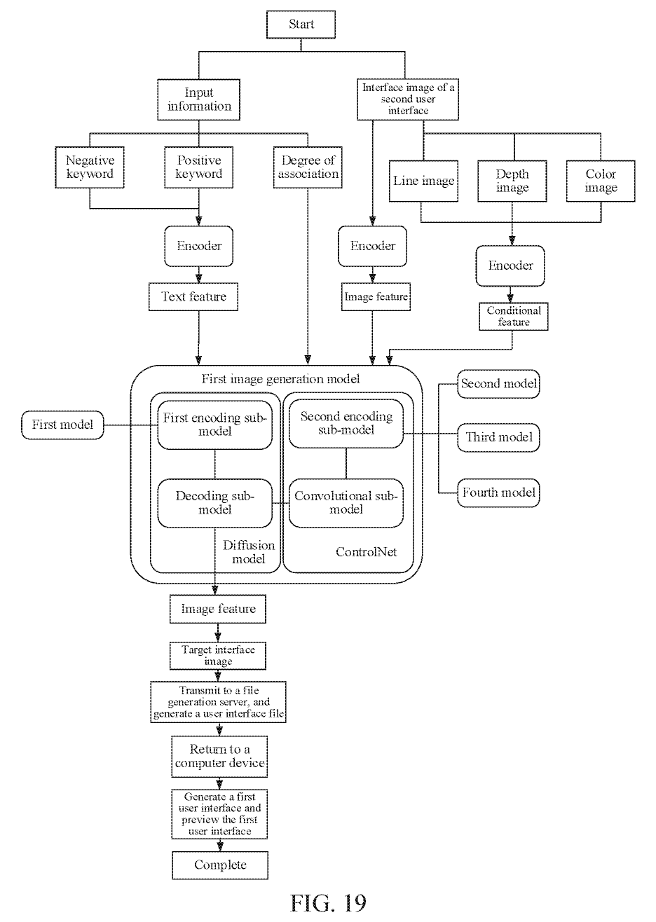

An operation process of generating a first user interface by a computer device is shown in FIG. 19. A diffusion model and ControlNet are trained based on a first model, a second model, a third model, and a fourth model. After the training is completed, a first image generation model may be deployed. The computer device obtains an interface image of a second user interface, a positive keyword, a negative keyword, and a degree of association through the application, encodes the positive keyword and the negative keyword to obtain text features, encodes the interface image of the second user interface to obtain an image feature, and inputs the text features, the image feature, and the degree of association into the diffusion model. In addition, a line image, a depth image, and a color image of the interface image of the second user interface are encoded to obtain conditional features, and the text feature and the conditional features are inputted into ControlNet. A processing process of the diffusion model may be considered as a process of predicting noise in the interface image of the second user interface and removing the noise from the interface image of the second user interface. In addition, the conditional feature also participates in removing the noise. Then, the diffusion model outputs an image feature, and the image feature is converted into a target interface image. The target interface image is an image obtained after the noise is removed from the interface image of the second user interface. The computer device uploads the target interface image to a file generation server. The file generation server generates a user interface file based on the target interface image, and returns the user interface file to the computer device locally. The computer device displays a new first user interface or previews the first user interface based on the user interface file.

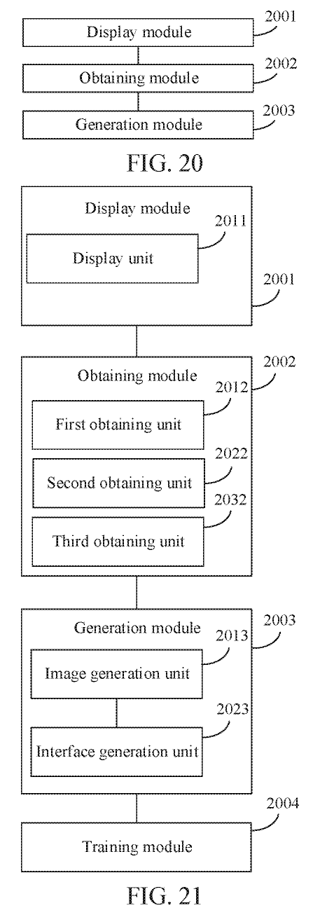

FIG. 20 is a schematic structural diagram of a user interface generation apparatus according to an embodiment of this application. Refer to FIG. 20. The apparatus includes: a display module 2001, configured to display a generation interface in an application in response to a generation instruction in the application, the generation instruction indicating that a user interface is generated for the application; an obtaining module 2002, configured to obtain a keyword inputted on the generation interface, the keyword being configured for describing a condition that a target user interface needs to satisfy; and a generation module 2003, configured to generate a first user interface based on the keyword, the first user interface matching the keyword, the display module 2001 being further configured to display the first user interface in the application.

According to the solution in the embodiments of this application, the function of generating a user interface is provided in the application, and when a computer device runs the application, the user interface matching the keyword can be generated based on the inputted keyword. In this way, personalization of the user interface is achieved. The user interface is no longer limited to a user interface created by a designer, attractiveness of the user interface is enhanced, and user stickiness of the application is increased. Designers do not need to create many different user interfaces, whereby manpower cost is reduced and user interface generation efficiency is enhanced.

In an embodiment, referring to FIG. 21, the obtaining module 2002 includes: a first obtaining unit 2012, configured to display a first input field on the generation interface, the first obtaining unit 2012 being further configured to obtain a positive keyword based on an input operation in the first input field, and the positive keyword being a keyword that needs to be associated with the target user interface.

In an embodiment, referring to FIG. 21, the obtaining module 2002 includes: a second obtaining unit 2022, configured to display a slider on the generation interface, the slider including a slider thumb, a position of the slider thumb representing a degree of association, the degree of association being a degree of association between the target user interface and the positive keyword, and the second obtaining unit 2022 being further configured to obtain, based on a sliding operation for the slider thumb, the degree of association represented by the position of the slider thumb. The generation module 2003 is configured to generate the first user interface based on the positive keyword and the degree of association represented by the position of the slider thumb.

In an embodiment, referring to FIG. 21, the obtaining module 2002 includes: a third obtaining unit 2032, configured to display a second input field on the generation interface, the third obtaining unit 2032 being further configured to obtain a negative keyword based on an input operation in the second input field, and the negative keyword being a keyword that does not need to be associated with the target user interface.

In an embodiment, referring to FIG. 21, the display module 2001 includes: a display unit 2011, configured to display an interface image of a second user interface on the generation interface, the second user interface being a currently used user interface of the application, and the display unit 2011 being further configured to replace the interface image of the second user interface with an interface image of the first user interface after the first user interface is generated.

In an embodiment, a user interface generation control is displayed in the application, and the display module 2001 is configured to display the generation interface in response to a trigger operation for the user interface generation control.

In an embodiment, the display module 2001 is further configured to display a user interface ranking list, the user interface ranking list including a plurality of user interfaces, and each user interface in the user interface ranking list being generated by the computer device running the application.

In an embodiment, referring to FIG. 21, the generation module 2003 includes: an image generation unit 2013, configured to generate a target interface image based on the interface image of the second user interface and the keyword through a first image generation model; and an interface generation unit 2023, configured to generate the first user interface based on the target interface image, the second user interface being the currently used user interface of the application.

In an embodiment, referring to FIG. 21, the interface generation unit 2023 is configured to recognize the target interface image, to obtain a plurality of interface elements in the target interface image and positions of the plurality of interface elements; and generate the first user interface based on the plurality of interface elements and the positions of the plurality of interface elements.

In an embodiment, referring to FIG. 21, the interface generation unit 2023 is configured to obtain an interface template; and fill the interface template with the plurality of interface elements according to the positions of the plurality of interface elements, to obtain the first user interface.

In an embodiment, the first image generation model includes a first encoding sub-model and a decoding sub-model, and the image generation unit 2013 is configured to encode the interface image of the second user interface, to obtain an image feature; encode the keyword, to obtain a text feature; encode the text feature and the image feature through the first encoding sub-model, to obtain an encoded feature; and decode the encoded feature through the decoding sub-model, to obtain the target interface image.

In an embodiment, the first encoding sub-model includes n first encoding blocks, n being an integer greater than 1; and the image generation unit 2013 is configured to encode the text feature and the image feature through the first first encoding block, to obtain the first encoded feature; encode the text feature and the (x–1)^{th} encoded feature through the x^{th} first encoding block, to obtain the x^{th} encoded feature, until the text feature and the (n–1)^{th} encoded feature are encoded through the n^{th} first encoding block, to obtain the n^{th} encoded feature, x being an integer greater than 1 but less than n.

In an embodiment, the first image generation model further includes a second encoding sub-model and a convolutional sub-model, and the image generation unit 2013 is further configured to encode a reference interface image, to obtain a conditional feature, the reference interface image including partial image information of the interface image of the second user interface, and the conditional feature indicating that the target interface image generated through the first image generation model needs to include the image information; encode the conditional feature and the image feature through the second encoding sub-model, to obtain a first conditional feature, and perform a convolution operation on the first conditional feature through the convolutional sub-model, to obtain a second conditional feature. The image generation unit 2013 is configured to decode the encoded feature and the second conditional feature through the decoding sub-model, to obtain the target interface image.

In an embodiment, the second encoding sub-model includes n second encoding blocks, the convolutional sub-model includes n convolutional layers, and the image generation unit 2013 is configured to perform a convolution operation on the conditional feature, and fuse a conditional feature obtained after the convolution operation with the image feature, to obtain a fused feature; encode the text feature and the fused feature through the first second encoding block, to obtain the first first conditional feature; encode the text feature and the (y–1)^{th} first conditional feature through the y^{th} second encoding block, to obtain the y^{th} first conditional feature, until the text feature and the (n–1)^{th} first conditional feature are encoded through the n^{th} second encoding block, to obtain the n^{th} first conditional feature, y being an integer greater than 1 but less than n; and respectively perform a convolution operation on the n first conditional features through the n convolutional layers, to obtain n second conditional features.

In an embodiment, the decoding sub-model includes n decoding blocks, and the image generation unit 2013 is configured to decode the text feature, the n^{th} encoded feature, and the first second conditional feature through the first decoding block, to obtain the first decoded feature; decode the text feature, the (n+1–z)^{th} encoded feature, and the z^{th} second conditional feature through the z^{th} decoding block, to obtain the z^{th} decoded feature, until the text feature, the first decoded feature, and the n^{th} second conditional feature are decoded through the n^{th} decoding block, to obtain the n^{th} decoded feature, z being an integer greater than 1 but less than n; and generate the target interface image based on the n^{th} decoded feature.

In an embodiment, a process of obtaining the reference interface image includes at least one of the following: a line image of the interface image of the second user interface is obtained, the line image including a line in the interface image of the second user interface; a depth image of the interface image of the second user interface is obtained, the depth image including a depth of each position in the interface image of the second user interface; and a color image of the interface image of the second user interface is obtained, the color image including a main color of each area in the interface image of the second user interface.

In an embodiment, referring to FIG. 21, the apparatus further includes a training module 2004. The training module 2004 is configured to train a second image generation model, the second image generation model including a first encoding sub-model and a decoding sub-model; copy the first encoding sub-model when the second image generation model satisfies a training end condition, to obtain the second encoding sub-model; and add the second encoding sub-model and the convolutional sub-model to the second image generation model, to obtain the first image generation model; and train the first image generation model when model parameters of the first encoding sub-model are kept unchanged, until the first image generation model satisfies the training end condition.

In an embodiment, the training module 2004 is configured to train the second image generation model based on a first model; and train the first image generation model based on at least one model of a second model, a third model, and a fourth model. The first model includes at least one image, and a text keyword and diffusion information of the at least one image. The second model includes at least one line image, and a text keyword and diffusion information of the at least one line image. The third model includes at least one depth image, and a text keyword and diffusion information of the at least one depth image. The fourth model includes at least one color image, and a text keyword and diffusion information of the at least one color image. The diffusion information of any image includes a noise image obtained by adding noise to the image and the noise.

The user interface generation apparatus provided in the foregoing embodiments is only illustrated by taking the division of the foregoing functional modules as an example. In practical application, the foregoing functions may be allocated to and completed by different functional modules according to requirements. That is, an internal structure of a computer device is divided into different functional modules, to complete all or some of the functions described above. In addition, the user interface generation apparatus provided in the foregoing embodiments and the user interface generation method embodiments belong to the same conception. For a specific implementation process of the user interface generation apparatus, refer to the method embodiments. Details are not described again here.

The embodiments of this application further provide a computer device. The computer device includes a processor and a memory. The memory has at least one computer program stored therein, and the processor loads and executes the at least one computer program, to implement the operations performed in the user interface generation method provided in the foregoing embodiments.

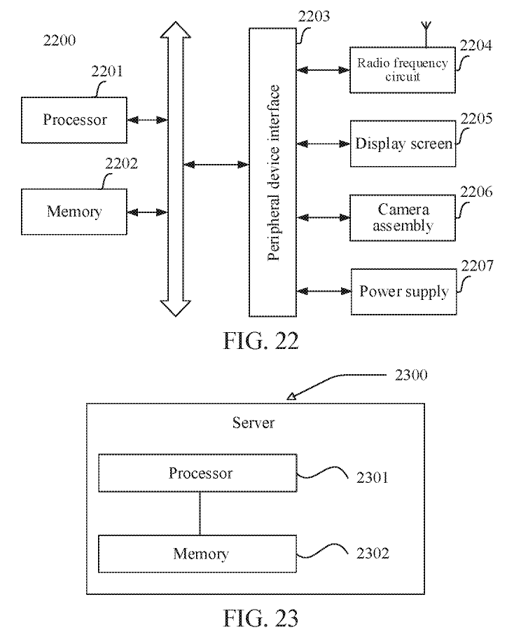

In an embodiment, the computer device is provided as a terminal. FIG. 22 is a schematic structural diagram of a terminal 2200 according to an exemplary embodiment of this application. The terminal 2200 includes a processor 2201 and a memory 2202.

The processor 2201 may include one or more processing cores, such as a 4-core processor or an 8-core processor. The processor 2201 may be implemented in at least one hardware form of a digital signal processor (DSP), a field-programmable gate array (FPGA), and a programmable logic array (PLA). The processor 2201 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 2201 may be integrated with a graphics processing unit (GPU). The GPU is configured to render and draw content that needs to be displayed on a display screen. In some embodiments, the processor 2201 may further include an artificial intelligence (AI) processor. The AI processor is configured to process computing operations related to machine learning.

The memory 2202 may include one or more computer-readable storage media. The computer-readable storage media may be non-transitory. The memory 2202 may further include a high-speed random-access memory, as well as non-volatile memory, such as one or more disk storage devices and flash storage devices. In some embodiments, the non-transitory computer-readable storage medium in the memory 2202 is configured to store at least one computer program. The at least one computer program is executed by the processor 2201 to implement the user interface generation method provided in the method embodiments of this application.

In some embodiments, the terminal 2200 may alternatively include: a peripheral device interface 2203 and at least one peripheral device. The processor 2201, the memory 2202, and the peripheral interface 2203 may be connected via a bus or a signal cable. Each peripheral device may be connected to the peripheral device interface 2203 via a bus, a signal cable, or a circuit board. In an embodiment, the peripheral device includes at least one of a radio frequency circuit 2204, a display screen 2205, a camera assembly 2206, and a power supply 2207.

A person skilled in the art may understand that the structure shown in FIG. 22 is not intended to be constructed as limiting the terminal 2200, and the terminal may include more or fewer components than those shown in the figure, or some components may be combined, or a different component deployment may be adopted.

In an embodiment, the computer device is provided as a server. FIG. 23 is a schematic structural diagram of a server according to an embodiment of this application. A server 2300 may vary significantly due to different configurations or performance, and may include one or more CPUs 2301 and one or more memories 2302. The memory 2302 has at least one computer program stored therein, and the processor 2301 loads and executes the at least one computer program to implement the method provided in the foregoing method embodiments. Certainly, the server may further include components such as a wired or wireless network interface, a keyboard, and an input/output interface, to perform input and output. The server may further include another component configured to implement a device function. Details are not described again here.

The embodiments of this application further provide a non-transitory computer-readable storage medium. The computer-readable storage medium has at least one computer program stored therein, and a processor loads and executes the at least one computer program, to implement the operations performed in the user interface generation method provided in the foregoing embodiments.

The embodiments of this application further provide a computer program product, including a computer program. A processor loads and executes the computer program, to implement the operations performed in the user interface generation method provided in the foregoing embodiments.

A person of ordinary skill in the art may understand that all or some of the operations of the foregoing embodiments may be implemented by hardware, or may be implemented by a program instructing relevant hardware. The program may be stored in a non-transitory computer-readable storage medium. The storage medium mentioned above may be a read-only memory, a magnetic disk, an optical disc, or the like.

The above descriptions are merely preferred embodiments of the embodiments of this application, and are not intended to limit the embodiments of this application. Any modification, equivalent substitution, improvement, or the like made within the spirit and principle of the embodiments of this application falls within the scope of protection of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A user interface generation method performed by a computer device, the method comprising:
displaying a generation interface in an application in response to a generation instruction in the application;
obtaining a keyword inputted on the generation interface, the keyword describing a condition that a target user interface needs to satisfy;
generating a first user interface based on the keyword, the first user interface matching the keyword; and
displaying the first user interface in the application.

2. The method according to claim 1, wherein the obtaining a keyword inputted on the generation interface comprises:
displaying a first input field on the generation interface; and
obtaining a positive keyword based on an input operation in the first input field, the positive keyword being a keyword associated with the target user interface.

3. The method according to claim 1, wherein the method further comprises:
displaying a slider on the generation interface, the slider comprising a slider thumb, a position of the slider thumb representing a degree of association, and the degree of association being a degree of association between the target user interface and the positive keyword;
obtaining, based on a sliding operation for the slider thumb, the degree of association represented by the position of the slider thumb; and
generating the first user interface based on the positive keyword and the degree of association represented by the position of the slider thumb.

4. The method according to claim 1, wherein the obtaining a keyword inputted on the generation interface comprises:
displaying a second input field on the generation interface; and
obtaining a negative keyword based on an input operation in the second input field, the negative keyword being a keyword that does not need to be associated with the target user interface.

5. The method according to claim 1, wherein the method further comprises:
displaying an interface image of a second user interface on the generation interface, the second user interface being a currently used user interface of the application; and
replacing the interface image of the second user interface with an interface image of the first user interface after the first user interface is generated.

6. The method according to claim 1, wherein the generating a first user interface based on the keyword comprises:
generating a target interface image based on the interface image of the second user interface and the keyword through a first image generation model; and
generating the first user interface based on the target interface image,
the second user interface being the currently used user interface of the application.

7. The method according to claim 6, wherein the generating the first user interface based on the target interface image comprises:
recognizing the target interface image, to obtain a plurality of interface elements in the target interface image and positions of the plurality of interface elements; and
generating the first user interface based on the plurality of interface elements and the positions of the plurality of interface elements.

8. The method according to claim 6, wherein the first image generation model comprises a first encoding sub-model and a decoding sub-model, and the generating a target interface image based on the interface image of the second user interface and the keyword through a first image generation model comprises:
encoding the interface image of the second user interface, to obtain an image feature;
encoding the keyword, to obtain a text feature;
encoding the text feature and the image feature through the first encoding sub-model, to obtain an encoded feature; and
decoding the encoded feature through the decoding sub-model, to obtain the target interface image.

9. A computer device, the computer device comprising a processor and a memory, the memory having at least one computer program stored therein, and the at least one computer program, when being loaded and executed by the processor, causing the computer device to implement a user interface generation method including:
displaying a generation interface in an application in response to a generation instruction in the application;
obtaining a keyword inputted on the generation interface, the keyword describing a condition that a target user interface needs to satisfy;
generating a first user interface based on the keyword, the first user interface matching the keyword; and
displaying the first user interface in the application.

10. The computer device according to claim 9, wherein the obtaining a keyword inputted on the generation interface comprises:
displaying a first input field on the generation interface; and
obtaining a positive keyword based on an input operation in the first input field, the positive keyword being a keyword associated with the target user interface.

11. The computer device according to claim 9, wherein the method further comprises:
displaying a slider on the generation interface, the slider comprising a slider thumb, a position of the slider thumb representing a degree of association, and the degree of association being a degree of association between the target user interface and the positive keyword;
obtaining, based on a sliding operation for the slider thumb, the degree of association represented by the position of the slider thumb; and
generating the first user interface based on the positive keyword and the degree of association represented by the position of the slider thumb.

12. The computer device according to claim 9, wherein the obtaining a keyword inputted on the generation interface comprises:
displaying a second input field on the generation interface; and
obtaining a negative keyword based on an input operation in the second input field, the negative keyword being a keyword that does not need to be associated with the target user interface.

13. The computer device according to claim 9, wherein the method further comprises:
displaying an interface image of a second user interface on the generation interface, the second user interface being a currently used user interface of the application; and
replacing the interface image of the second user interface with an interface image of the first user interface after the first user interface is generated.

14. The computer device according to claim 9, wherein the generating a first user interface based on the keyword comprises:
generating a target interface image based on the interface image of the second user interface and the keyword through a first image generation model; and
generating the first user interface based on the target interface image,
the second user interface being the currently used user interface of the application.

15. The computer device according to claim 14, wherein the generating the first user interface based on the target interface image comprises:
recognizing the target interface image, to obtain a plurality of interface elements in the target interface image and positions of the plurality of interface elements; and
generating the first user interface based on the plurality of interface elements and the positions of the plurality of interface elements.

16. The computer device according to claim 14, wherein the first image generation model comprises a first encoding sub-model and a decoding sub-model, and the generating a target interface image based on the interface image of the second user interface and the keyword through a first image generation model comprises:
encoding the interface image of the second user interface, to obtain an image feature;
encoding the keyword, to obtain a text feature;
encoding the text feature and the image feature through the first encoding sub-model, to obtain an encoded feature; and
decoding the encoded feature through the decoding sub-model, to obtain the target interface image.

17. A non-transitory computer-readable storage medium, the computer-readable storage medium having at least one computer program stored therein, and the at least one computer program, when being loaded and executed by a processor of a computer device, causing the computer device to implement a user interface generation method including:
displaying a generation interface in an application in response to a generation instruction in the application;
obtaining a keyword inputted on the generation interface, the keyword describing a condition that a target user interface needs to satisfy;
generating a first user interface based on the keyword, the first user interface matching the keyword; and
displaying the first user interface in the application.

18. The non-transitory computer-readable storage medium according to claim 17, wherein the obtaining a keyword inputted on the generation interface comprises:
displaying a first input field on the generation interface; and
obtaining a positive keyword based on an input operation in the first input field, the positive keyword being a keyword associated with the target user interface.

19. The non-transitory computer-readable storage medium according to claim 17, wherein the method further comprises:
displaying a slider on the generation interface, the slider comprising a slider thumb, a position of the slider thumb representing a degree of association, and the degree of association being a degree of association between the target user interface and the positive keyword;
obtaining, based on a sliding operation for the slider thumb, the degree of association represented by the position of the slider thumb; and
generating the first user interface based on the positive keyword and the degree of association represented by the position of the slider thumb.

20. The non-transitory computer-readable storage medium according to claim 17, wherein the obtaining a keyword inputted on the generation interface comprises:
displaying a second input field on the generation interface; and
obtaining a negative keyword based on an input operation in the second input field, the negative keyword being a keyword that does not need to be associated with the target user interface.
